(19) United States
(12) Patent Application Publication
(10) Pub. No.: US 2019/0213411 A1
(43) Pub. Date: Jul. 11, 2019

(54) THERMAL IMAGING FOR SPACE USAGE ALAYSIS

(71) Applicant: SIGNIFY HOLDING B.V., EINDHOVEN (NL)

(72) Inventors: RUBEN RAJAGOPALAN, NEUSS (DE); HARRY BROERS, 'S-HERTOGENBOSCH (NL)

(21) Appl. No.: 16/335,906

(22) PCT Filed: Sep. 18, 2017
(86) PCT No.: PCT/EP2017/073460

§ 371 Date: Mar. 22, 2019

(30) Foreign Application Priority Data
Sep. 22, 2016 (EP) 16190020.4

(51) Int. Cl. G06K 9/00; H05B 37/02; H04N 5/33

(52) U.S. Cl. CPC G06K 9/00624; H04N 5/33; H05B 37/0227

(57) ABSTRACT

A method (300) for characterizing a lighting environment using thermal imaging includes the steps of: providing (310) a lighting unit (10) comprising a light source (12), a thermal imager (32), and a controller (22); obtaining (330), using the thermal imager, one or more thermal images of one or more surfaces (52) within the lighting environment; extracting (340), by the controller using the one or more thermal images, a thermal heating 5 pattern for one or more surfaces within the lighting environment; and characterizing (360), by the controller using the extracted thermal heating pattern, the one or more surfaces within the lighting environment.

### FIELD OF THE INVENTION

The present disclosure is directed generally to methods and systems for luminaires with integrated thermal imaging configured to monitor or characterize an environment.

### BACKGROUND

Sensor-driven lighting units monitor a characteristic of the environment with a sensor and utilize the sensor data to control the light source of the lighting unit, or to reveal other information about the environment. The most common example of sensor-driven lighting units are systems that monitor light levels using integrated photocells that measure ambient light levels. For example, night lights use ambient light to turn on when ambient light levels decrease and to turn off when ambient light levels increase. As another example, some sensor-driven luminaries measure reflected light coming from a surface below and dim the light output when the light level exceeds a predefined light level. Since these luminaires integrate all the reflected light into a single light level, there can be incorrect measurements such as in the case of striped patterns casted by blinds or shadows casted by trees. Accordingly, these solutions often provide sub-optimal light level monitoring, thereby resulting in an overall poor system performance.

Another common example of sensor-driven lighting units are systems that monitor the occupancy state of a room. These luminaires use a variety of mechanisms, including ambient light levels, motion detection, and thermal imaging to detect a presence in a room and control the luminaire accordingly. For example, in an office setting, objects with a thermal signature such as people are detected by a thermal imager and thus informs the lighting system that a person is present. These thermal imaging luminaires function largely to detect the presence of an individual in a room. However, there is other information that can be extracted from the thermal imaging to maximize the efficiency and functionality of the lighting system.

Accordingly, there is a continued need in the art for methods and lighting systems that utilize a luminaire with a thermal imager to extract information about an environment in addition to presence detection.

### SUMMARY OF THE INVENTION

The present disclosure is directed to inventive methods and apparatus for monitoring a lighting environment using thermal imaging. Various embodiments and implementations herein are directed to a lighting unit with a thermal imager. The thermal images are analyzed to extract thermal heating patterns within the environment to identify areas that are touched by occupants. The extracted information can be used to identify and localize furniture to evaluate office space usage. The extracted information can also be used to characterize the activity level of occupants within the room, and to create a heat map of touched surfaces which can then facilitate cleaning schedules.

Generally, in one aspect, a method for characterizing a lighting environment using thermal imaging is provided. The method includes the steps of: (i) providing a lighting unit comprising a light source, a thermal imager, and a controller; (ii) obtaining, using the thermal imager, one or more thermal images of one or more surfaces within the lighting environment; (iii) extracting, by the controller using the one or more thermal images, a thermal heating pattern for one or more surfaces within the lighting environment; and (iv) characterizing, by the controller using the extracted thermal heating pattern, the one or more surfaces within the lighting environment.

According to an embodiment, the method further includes the step of communicating, using a communications module of the lighting unit, the extracted thermal heating pattern.

According to an embodiment, the step of extracting a thermal heating pattern comprises comparing a thermal image at a first time point to a thermal image at a second time point.

According to an embodiment, the step of characterizing the one or more surfaces within the lighting environment comprises identifying the one or more surfaces.

According to an embodiment, the step of characterizing the one or more surfaces within the lighting environment comprises localizing the one or more surfaces within the lighting environment.

According to an embodiment, the one or more surfaces comprise furniture within the lighting environment.

According to another aspect is a method for characterizing an activity level within a lighting environment using thermal imaging. The method includes the steps of: (i) providing a lighting unit comprising a light source, a thermal imager, and a controller; (ii) obtaining, using the thermal imager, one or more thermal images of one or more surfaces within the lighting environment; (iii) extracting, by the controller using the one or more thermal images, a thermal heating pattern for one or more surfaces within the lighting environment; and (iv) characterizing, by the controller using the extracted thermal heating pattern, an activity level within the lighting environment.

According to an embodiment, the step of characterizing an activity level within the lighting environment comprises creating a heat map of at least a portion of the lighting environment.

According to an embodiment, the step of characterizing an activity level within the lighting environment comprises characterizing usage of one or more surfaces within the lighting environment.

According to an embodiment, the method further includes the step of managing, using the characterized activity level, the lighting environment.

According to another aspect is a method for managing cleaning within a lighting environment. The method includes the steps of: (i) providing a lighting unit comprising a light source, a thermal imager, and a controller; (ii) obtaining, using the thermal imager, one or more thermal images of one or more surfaces within the lighting environment; (iii) extracting, by the controller using the one or more thermal images, a thermal heating pattern for one or more surfaces within the lighting environment; (iv) creating, by the controller using the extracted thermal heating pattern, a heat map of at least a portion of the lighting environment; and managing, using the created heat map, cleaning of at least a portion of the lighting environment.

According to an embodiment, the step of managing cleaning of at least a portion of the lighting environment comprises an indication that the lighting environment, or one or more surfaces within the lighting environment, should be cleaned.

According to an embodiment, the step of managing cleaning of at least a portion of the lighting environment comprises an indication that the lighting environment, or one or more surfaces within the lighting environment, does not need cleaning.

According to another aspect is a lighting unit configured to characterize a lighting environment using thermal imaging. The lighting unit includes: a light source, a thermal imager configured to obtain one or more thermal images of one or more surfaces within the lighting environment; and a controller configured to (i) extract, using the one or more thermal images, a thermal heating pattern for one or more surfaces within the lighting environment; and (ii) characterize, using the extracted thermal heating pattern, the one or more surfaces within the lighting environment.

According to an embodiment, the step of characterizing the one or more surfaces within the lighting environment comprises identifying the one or more surfaces, localizing the one or more surfaces within the lighting environment, characterizing an activity level within the lighting environment, or managing cleaning of at least a portion of the lighting environment.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, tribo luminescent sources, sonoluminescent sources, radio luminescent sources, and luminescent polymers.

A given light source may be configured to generate electromagnetic radiation within the visible spectrum, outside the visible spectrum, or a combination of both. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic representation of a lighting unit, in accordance with an embodiment.

FIG. 2 is a schematic representation of a lighting system, in accordance with an embodiment.

FIG. 3 is a flow chart of a method for monitoring a lighting environment using thermal imaging data, in accordance with an embodiment.

### DETAILED DESCRIPTION OF EMBODIMENTS

The present disclosure describes various embodiments of a lighting unit configured to monitor a lighting environment. More generally, Applicant has recognized and appreciated that it would be beneficial to provide a lighting unit, fixture, or system that obtains thermal images of the lighting environment. A particular goal of utilization of certain embodiments of the present disclosure is to characterize the lighting environment using thermal imaging information.

In view of the foregoing, various embodiments and implementations are directed to a lighting unit or system with a thermal imager that obtains thermal images of the lighting environment. A processor of the lighting unit or system extracts thermal heating patterns or information from within the environment to identify one or more areas touched by an occupant. Extracted thermal information can also be used to identify and localize furniture to evaluate office space usage, to characterize the activity level of occupants within the room, and/or to create a heat map of touched surfaces which can then facilitate cleaning schedules, maintenance, or other aspects of environmental care.

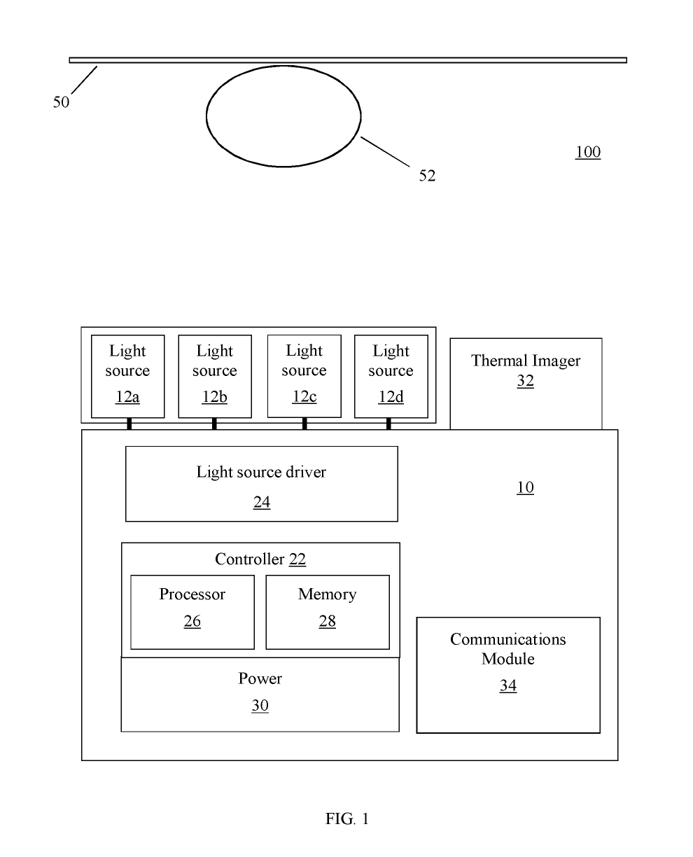

Referring to FIG. 1, in one embodiment, a lighting unit 10 is provided that includes one or more light sources 12, where one or more of the light sources may be an LED-based light source. Further, the LED-based light source may have one or more LEDs. The light source can be driven to emit light of predetermined character (i.e., color intensity, color temperature) by one or more light source drivers 24. Many different numbers and various types of light sources (all LED-based light sources, LED-based and non-LED-based light sources alone or in combination, etc.) adapted to generate radiation of a variety of different colors may be employed in the lighting unit 10. According to an embodiment, lighting unit 10 can be any type of lighting fixture, including but not limited to a night light, a street light, a table lamp, or any other interior or exterior lighting fixture. According to an embodiment, lighting unit 10 is configured to illuminate all or a portion of a target surface 50 and/or an object 52 within the lighting environment.

According to an embodiment, lighting unit 10 includes a controller 22 that is configured or programmed to output one or more signals to drive the one or more light sources 12a-d and generate varying intensities, directions, and/or colors of light from the light sources. For example, controller 22 may be programmed or configured to generate a control signal for each light source to independently control the intensity and/or color of light generated by each light source, to control groups of light sources, or to control all light sources together. According to another aspect, the controller 22 may control other dedicated circuitry such as light source driver 24 which in turn controls the light sources so as to vary their intensities. Controller 22 can be or have, for example, a processor 26 programmed using software to perform various functions discussed herein, and can be utilized in combination with a memory 28. Memory 28 can store data, including one or more lighting commands or software programs for execution by processor 26, as well as various types of data including but not limited to specific identifiers for that lighting unit. For example, the memory 28 may be a non-transitory computer readable storage medium that includes a set of instructions that are executable by processor 26, and which cause the system to execute one or more of the steps of the methods described herein.

Controller 22 can be programmed, structured and/or configured to cause light source driver 24 to regulate the intensity and/or color temperature of light source 12 based on predetermined data, such as ambient light conditions, among others, as will be explained in greater detail hereinafter. According to one embodiment, controller 22 can also be programmed, structured and/or configured to cause light source driver 24 to regulate the intensity and/or color temperature of light source 12 based on communications received by a wireless communications module 34.

Lighting unit 10 also includes a source of power 30, most typically AC power, although other power sources are possible including DC power sources, solar-based power sources, or mechanical-based power sources, among others. The power source may be in operable communication with a power source converter that converts power received from an external power source to a form that is usable by the lighting unit. In order to provide power to the various components of lighting unit 10, it can also include an AC/DC converter (e.g., rectifying circuit) that receives AC power from an external AC power source 30 and converts it into direct current for purposes of powering the light unit's components. Additionally, lighting unit 10 can include an energy storage device, such as a rechargeable battery or capacitor, that is recharged via a connection to the AC/DC converter and can provide power to controller 22 and light source driver 24 when the circuit to AC power source 30 is opened.

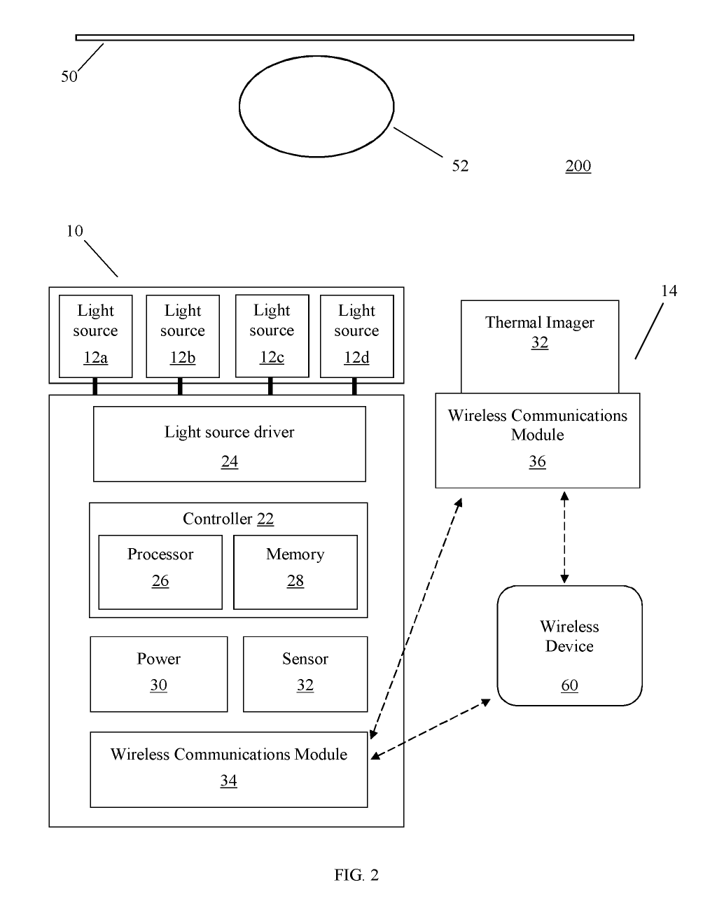

In addition, lighting unit 10 includes a thermal imager 32 which is connected to an input of controller 22 and collects thermal images in or from the vicinity of lighting unit 10 and can transmit data to controller 22, or externally via wireless communications module 34, that is representative of the thermal images it collects. In some embodiments such as system 200 depicted in FIG. 2, thermal imager 32 is remote from the lighting unit 10 and transmits obtained thermal imaging data to wireless communications module 34 of the lighting unit. The wireless communications module 34 can be, for example, Wi-Fi, Bluetooth, IR, radio, or near field communication that is positioned in communication with controller 22 or, alternatively, controller 22 can be integrated with the wireless communications module.

Referring to FIG. 2, in one embodiment, a lighting system 200 is provided that includes a lighting unit 10. Lighting unit 10 can be any of the embodiments described herein or otherwise envisioned, and can include any of the components of the lighting units described in conjunction with FIG. 1, such as one or more light sources 12, light source driver 24, controller 22, and wireless communications module 34, among other elements. Lighting system 200 also includes a thermal imager component 14 which includes a thermal imager 32 and a wireless communications module 36, among other elements. Wireless communications modules 34 and 36 can be, for example, Wi-Fi, Bluetooth, IR, or near field communication that is positioned in communication with each other and/or with a wireless device 60, which can be, for example, a network, a computer, a server, or a handheld computing device, among other wireless devices.

According to an embodiment, either of lighting system 100 or 200 can comprise multiple lighting units 10, each with one or more light sources 12. For example, lighting system 100 or 200 can be an entire office building, a floor of a building, a suite of rooms, a complex of buildings, or any other configuration comprise multiple lighting units. These multiple lighting units can be configured to communicate with each other and/or with a central computer, server, or other central hub. One or more aspects of the functionality of the methods and systems described or otherwise envisioned herein may occur within the central hub rather than within the individual lighting units. For example, the central hub may extract information from thermal images captured by one or more lighting units and transmitted or otherwise communicated to the central hub.

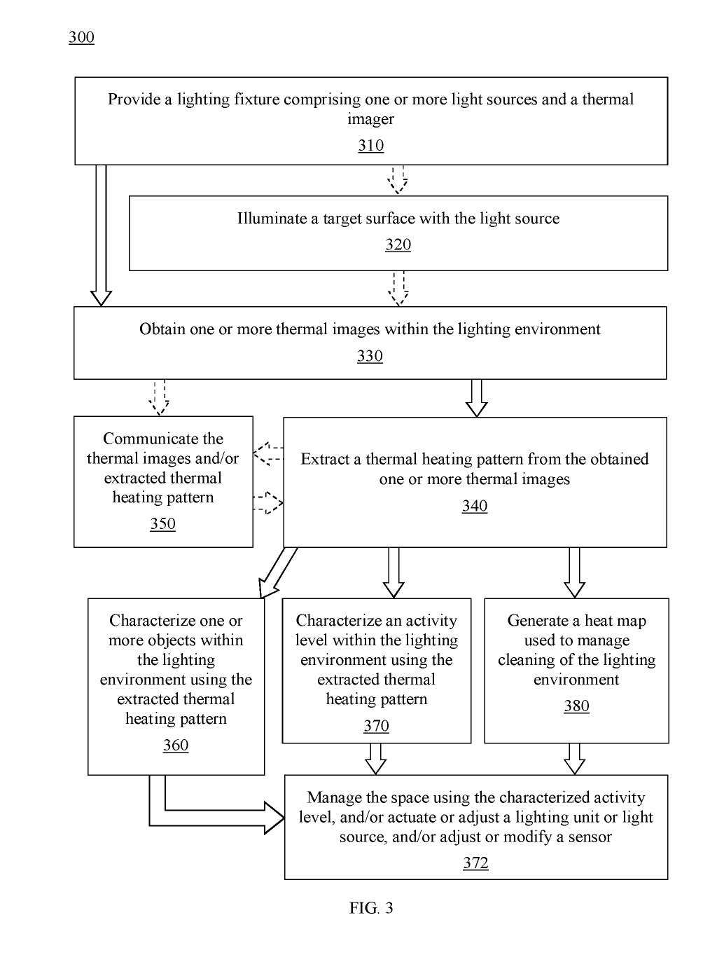

Referring to FIG. 3, in one embodiment, a flow chart illustrating a method 300 for using thermal imaging to extract information about a lighting environment. At step 310 of the method, a lighting unit 10 and/or lighting system 100 or 200 is provided. Lighting unit 10 and/or lighting system 100 or 200 can be any of the embodiments described herein or otherwise envisioned, and can include any of the components of the lighting units described in conjunction with FIGS. 1 and 2, such as one or more light sources 12, light source driver 24, controller 22, thermal imager 32, and wireless communications module 34, among other elements. According to an embodiment, lighting unit 10 is configured to illuminate all or a portion of a target surface 50.

At optional step 320 of the method, the lighting unit illuminates all or a portion of the target surface 50. According to one embodiment, the lighting unit is an indoor lighting fixture and is configured to illuminate a target surface such as a room or hallway. The lighting unit may automatically illuminate the lighting environment during a predetermined period, or may be activated and deactivated by users. The lighting unit may be configured to respond to occupancy, thereby deactivating when there are no occupants and activating when occupants are detected. According to another embodiment, the lighting unit can detect ambient light levels and based on a predetermined threshold can activate and deactivate the light sources.

At step 330 of the method, the thermal imager 32 of the lighting unit obtains one or more thermal images of one or more locations within the target surface 50, of the one or more objects 52, and/or one or more other thermal images within the lighting environment. The thermal imager can be, for example, any thermal imager capable of obtaining thermal images of the lighting environment. The thermal imager communicates the thermal images or thermal imaging information to the controller 22, where the information can be analyzed and/or can be stored within memory 28. According to one embodiment, the thermal imager obtains thermal imaging data continuously. According to another embodiment, the thermal imager obtains thermal imaging data periodically, such as one every minute or multiple times per minute, among many other periods of time. According to one embodiment, the thermal imager communicates or controller 22 communicates the thermal images to a central hub for analysis.

At step 340 of the method, a processor such as processor 26 and/or controller 22 analyzes the thermal imaging data and extracts a thermal heating pattern from one or more thermal images, one or more surfaces, and/or the lighting environment. When an object such as a human being is located within the lighting environment, the thermal energy emitted by the human body is acquired by the thermal imager, and with image analysis the presence and location of a person can be derived. When an individual makes physical contact with an object within the lighting environment, some of the individual's body heat is transferred to the object. The thermal imprint will be clearly visible with the thermal imager, and will slowly fade away over time. For example, heat transferred from the individual's handprint and/or fingertips may be distinguishable after the individual has touched a surface.

As another example, the thermal images will detect heat transferred from an individual to furniture within the lighting environment. As an individual sits in or interacts with furniture such as a sofa, chair, table, keyboard, desk, wall, or other surface, heat is transferred from the individual to that surface. The processor can then extract a thermal heating pattern from one or more thermal images of that surface and can determine that heat was transferred, thereby indicating that an individual was present and sat in, touched, or otherwise used that surface.

According to one embodiment, the thermal heating pattern is obtained over time. For example, the pattern may be detected or obtained by comparing a thermal image at a first time T1 to a thermal image obtained later at a second time T2. Differences between the T1 thermal image and the T2 thermal image may indicate heating and/or cooling of one or more surfaces within the image, thereby characterizing that surface.

At optional step 350 of the method, the thermal images and/or extracted thermal heating pattern are communicated from the lighting unit 10 to another lighting unit 10, to a component of a lighting system 100 or 200, and/or to a central hub, computer, server, or processor. The lighting unit 10 may be in direct and/or networked wired and/or wireless communication with the other lighting unit 10, the component of a lighting system 100 or 200, and/or the central hub, computer, server, or processor. Accordingly, the other lighting unit 10, the component of a lighting system 100 or 200, and/or the central hub, computer, server, or processor may be located nearby or remote from the lighting unit 10.

At step 360 of the method, the extracted thermal heating pattern is utilized to characterize one or more objects within the lighting environment. For example, the heating pattern can be utilized by the system to identify and/or localize furniture such as desks, tables, couches, or other furniture within the lighting environment, thereby allowing for the evaluation of space layout and usage. An individual sitting in a chair, for example, will transfer heat energy to the seat; when the individual leaves the chair, the seat can be recognized by its thermal characteristics. Desk surfaces, keyboards, and similar surfaces could also be identified when they are regularly heated up by user contact. Pattern recognition could be utilized to identify a type of furniture or surface within the thermally imaged space. Alternatively or in addition, the system may have a selection of possible furniture or object types from which to choose. As another option, the space may be pre-defined, mapped, or characterized within the system, and the extracted thermal heating pattern may be compared to the pre-defined map in order to determine that an object has been moved.

At step 370 of the method, the extracted thermal heating pattern is utilized to characterize an activity level within the lighting environment, and/or to create a heat map of the space. For example, the extracted thermal heating pattern can be analyzed to determine a level of touch interactions, or the amount of interaction between one or more individuals and one or more surfaces, within the lighting environment. The system may determine from extracted thermal heating patterns over the course of a day or other time period, for example, that one or more individuals have entered the space x number of times and have spent a total of y minutes within the space during the workday between the hours of 9 AM and 5 PM. The system may determine from extracted thermal heating patterns, for example, that a room has not be used in several days. The system may also determine from extracted thermal heating patterns that a particular item within the room is utilized regularly, such as a computer, desk, or chair. In a space with multiple pieces of furniture, the system can utilize extracted thermal heating patterns to determine which of the multiple pieces of furniture are most commonly utilized, least utilized, never utilized, always utilized, utilized above or below a threshold, or a variety of other determinations.

Accordingly, at step 372 of the method, the system can utilize the characterized activity level within the lighting environment to manage the lighting environment. For example, the system may determine—or may share the information with a user—that a particular piece of furniture within a room is never utilized, and thus that it should be removed for efficiency. The system may alternatively determine that a particular surface or piece of furniture is always utilized, and thus that a duplicate surface or piece of furniture may be necessary. Many other methods of managing the lighting environment based on a characterized activity level are possible.

At step 380 of the method, the extracted thermal heating pattern is utilized to create a heat map of surfaces that have received thermal energy at certain time points or over time, indicating that they have been touched by an individual. The generated heat map can then be utilized to manage cleaning of the lighting environment. For example, facility management services may use the heat map information to determine what spaces have been used and should be cleaned, and/or which surfaces within those spaces have been used and should be cleaned. For example, a desk or table may not need cleaning if the heat map or extracted thermal heating pattern indicates that it has not been utilized. Alternatively, the desk or table may need immediate cleaning if the heat map or extracted thermal heating pattern indicates that it has been utilized. Surface interactions or utilization sufficient to trigger a need for cleaning may be any use, or it may only be use above a predetermined threshold. This allows for optimization of cleaning services.

At an optional step 372 of the method, the controller utilizes the extracted thermal heating pattern to adjust or otherwise adapt the light profile emitted by the lighting unit or system. According to an embodiment, the controller can adjust the beam width, angle, and/or intensity of one or more light sources. The information could also be utilized to control the sensitivity and/or performance of one or more other sensors in order to reduce the effect of false triggers, such as activation and/or inactivation of a light source. Similarly, the information could be utilized to change a feature, parameter, or characteristic of the lighting environment over which the system has control.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for characterizing a lighting environment using thermal imaging, the method comprising the steps of:
providing a lighting unit comprising a light source, a thermal imager, and a controller;
obtaining, using the thermal imager, one or more thermal images of one or more surfaces within the lighting environment;
extracting, by the controller using the one or more thermal images, a thermal heating pattern for one or more surfaces within the lighting environment, the extraction being based at least in part on temporary thermal imprints on the one or more surfaces arising out of the transfer of body heat upon contact between a warmer body and a cooler surface; and
characterizing, by the controller using the extracted thermal heating pattern, the one or more surfaces within the lighting environment.

2. The method of claim 1, further comprising the step of communicating, using a communications module of the lighting unit, the extracted thermal heating pattern.

3. The method of claim 1, wherein the step of extracting a thermal heating pattern comprises comparing a thermal image at a first time point to a thermal image at a second time point.

4. The method of claim 1, wherein characterizing the one or more surfaces within the lighting environment comprises identifying the one or more surfaces.

5. The method of claim 1, wherein characterizing the one or more surfaces within the lighting environment comprises localizing the one or more surfaces within the lighting environment.

6. The method of claim 1, further comprising the step of modifying the light source or the thermal imager based on the characterization of the one or more surfaces within the lighting environment.

7. A method for characterizing an activity level within a lighting environment using thermal imaging, the method comprising the steps of:
providing a lighting unit comprising a light source, a thermal imager, and a controller;
obtaining, using the thermal imager, one or more thermal images of one or more surfaces within the lighting environment;
extracting, by the controller using the one or more thermal images, a thermal heating pattern for one or more surfaces within the lighting environment, the extraction being based at least in part on temporary thermal imprints on the one or more surfaces arising out of the transfer of body heat upon contact between a warmer body and a cooler surface; and
characterizing, by the controller using the extracted thermal heating pattern, an activity level within the lighting environment.

8. The method of claim 7, wherein characterizing an activity level within the lighting environment comprises creating a heat map of at least a portion of the lighting environment.

9. The method of claim 7, wherein characterizing an activity level within the lighting environment comprises characterizing usage of one or more surfaces within the lighting environment.

10. The method of claim 7, further comprising the step of managing, using the characterized activity level, the lighting environment.

11. A method for managing cleaning within a lighting environment, the method comprising the steps of:
providing a lighting unit comprising a light source, a thermal imager, and a controller;
obtaining, using the thermal imager, one or more thermal images of one or more surfaces within the lighting environment;
extracting, by the controller using the one or more thermal images, a thermal heating pattern for one or more surfaces within the lighting environment, the extraction being based at least in part on temporary thermal imprints on the one or more surfaces arising out of the transfer of body heat upon contact between a warmer body and a cooler surface;
creating, by the controller using the extracted thermal heating pattern, a heat map of at least a portion of the lighting environment; and
managing, using the created heat map, cleaning of at least a portion of the lighting environment.

12. The method of claim 11, wherein managing cleaning of at least a portion of the lighting environment comprises an indication that the lighting environment, or one or more surfaces within the lighting environment, should be cleaned.

13. The method of claim 11, wherein managing cleaning of at least a portion of the lighting environment comprises an indication that the lighting environment, or one or more surfaces within the lighting environment, does not need cleaning.

14. A lighting unit configured to characterize a lighting environment using thermal imaging, the lighting unit comprising:
a light source;
a thermal imager configured to obtain one or more thermal images of one or more surfaces within the lighting environment; and
a controller configured to (i) extract, using the one or more thermal images, a thermal heating pattern for one or more surfaces within the lighting environment, the extraction being based at least in part on temporary thermal imprints on the one or more surfaces arising out of the transfer of body heat upon contact between a warmer body and a cooler surface; and (ii) characterize, using the extracted thermal heating pattern, the one or more surfaces within the lighting environment.

15. The lighting unit of claim 14, wherein characterizing the one or more surfaces within the lighting environment comprises identifying the one or more surfaces, localizing the one or more surfaces within the lighting environment, characterizing an activity level within the lighting environment, or managing cleaning of at least a portion of the lighting environment.
